(19) United States
(12) Patent Application Publication
(10) Pub. No.: US 2006/0102266 A1
(43) Pub. Date: May 18, 2006

(54) Motorcycle tire

(75) Inventors: Loic Ravasio, Mairy (FR); Fabien Jean-Christophe Desarcon, Bivange (LU)

Correspondence Address: Roger D. Emerson, Esq.;BROUSE McDOWELL, Suite 500, 388 South Main Street, Akron, OH, 44311-4407, US

(73) Assignee: THE GOODYEAR TIRE & RUBBER COMPANY

(21) Appl. No.: 10/987,493

(22) Filed: Nov. 12, 2004

(51) Int. Cl. B60C 11/00; B60C 1/00

(52) U.S. Cl. 152/209.5; 152/209.11

(57) ABSTRACT

According to one aspect of the present invention, a new and improved motorcycle tire is provided which comprises a pair of beads, a carcass extending between the beads, a tread disposed outwardly of the carcass where the tread has tread edges. The tire further comprises a pair of sidewalls extending from the tread edges to the respective beads. The tread further includes a first rubber composition having a working temperature and a second rubber composition having a working temperature, wherein the first rubber composition reaches its working temperature faster than the second rubber composition reaches its working temperature. The first rubber composition and the second rubber composition are adapted to contact an associated underlying surface. The combination of the first rubber composition and the second rubber composition provides more even wear across the tire tread in order to increase the life of a tire and provide better tire performance.

### I. BACKGROUND OF THE INVENTION

A. Field of Invention

This invention pertains to the art of methods and apparatuses for a motorcycle tire, and more specifically, a motorcycle tire having tread formed from a combination of soft, medium, and hard rubbers to provide for more even wear of the tire tread.

B. Description of the Related Art

Treads of rubber tires are often prepared of a cap base construction in which the outer portion of the tread is the cap and the underlying part of the tread between the tread cap and the supporting tire carcass, is its base. The cap portion is usually designed to be ground contacting and, thus, have associated properties. The base portion generally overlays the tire carcass and is usually designed to support the cap, therefore, not to be ground contacting. Such cap base constructions are well known to those skilled in the art.

It is known in the art for tread of motorcycle tires to be made from the same rubber composition, namely, hard, medium, or soft rubber. Generally, a high performance tire utilizes soft rubber in the tread for a better grip or traction on the roadway or other underlying surface. Improved grip can be attributed to soft rubber reaching its “working temperature” more quickly than a medium or hard rubber. “Working temperature” means the temperature when the grip is optimum. While the grip of a high performance tire is high, the tire tread wears quickly. To the contrary, normal tires use a hard rubber and its wear is relatively slower than a soft rubber. Further, the grip for a normal tire is lower, and it takes longer for the hard rubber to reach its “working temperature.” In the art of motorcycle tires, motorcycle tires are often worn on its top, as shown in FIG. 2, whereas the sidewalls are almost new or at least less worn. This irregular wear could change the ride behavior of the motorcycle tire.

Based upon the foregoing, to avoid irregular wear in high performance tires, it is desirable to use a harder rubber in the tread region. However, uneven wear, or the use of a harder rubber during high speed drives, may have an effect on handling, especially during acceleration, braking, and steering around curves. Currently, riders choose between different types of tires according to his or her driving style, whether the driving style is long distance driving, leisurely drives where the driver steers around gentle curves in the roadway, or a sport style where the driver quickly accelerates and decelerates along the roadway. As such, there is a need in the art to provide a motorcycle tire that uses different rubbers in the tire tread so that one tire can accommodate different driving styles.

### II. SUMMARY OF THE INVENTION

According to one aspect of the present invention, a new and improved motorcycle tire is provided which comprises a pair of beads, a carcass extending between the beads, a tread disposed outwardly of the carcass where the tread has tread edges. The tire further comprises a pair of sidewalls extending from the tread edges to the respective beads. The tread further includes a first rubber composition having a working temperature and a second rubber composition having a working temperature, wherein the first rubber composition reaches its working temperature faster than the second rubber composition reaches its working temperature. The first rubber composition and the second rubber composition are adapted to contact an associated underlying surface. The combination of the first rubber composition and the second rubber composition is intended to provide more even wear across the tire tread in order to increase the life of a tire and provide better tire performance.

It is yet another object of the present invention to provide a motorcycle tire where the pair of sidewalls may be comprised of the first rubber composition.

It is yet another object of the present invention wherein the tread may further comprise a tread base and a tread cap such that the first rubber composition and the second rubber composition extend from the tread base to the tread cap.

It is yet another object of the present invention to provide a motorcycle tire wherein the tread may further comprise a third rubber composition having a working temperature, wherein the working temperature of the third rubber composition reaches its working temperature slower than the second rubber composition reaches its working temperature.

Still yet, another object of the present invention is to provide a motorcycle tire wherein the tire may have a first radius and a second radius, the first and second radii intersect the tread, and the second rubber composition may be juxtaposed to the first rubber composition and may be between the first and second radii.

Further, another object of the present invention is to provide a motorcycle tire wherein the tire may have a first radius, a second radius, a third radius, and a fourth radius, each of the radii intersecting the tread, the tread may further comprise a third rubber composition, wherein the third rubber composition may be juxtaposed to the second rubber composition between the first radii and the second radii, the second rubber composition may be juxtaposed to the first rubber composition and the third rubber composition between the first and third radii, and the third rubber composition may also be juxtaposed to the first rubber composition and the third rubber composition between the second and fourth radii.

It is yet another object of the present invention to provide a motorcycle wherein the first rubber composition may be a soft rubber, the second rubber composition may be a medium rubber, and a third rubber composition may be a hard rubber.

Still yet, another object of the present invention is to provide a motorcycle tire wherein a portion of the first rubber composition may be juxtaposed between the second rubber composition such that the second rubber composition is segmented into two portions.

Still yet, another object of the present invention is to provide a motorcycle tire wherein the first rubber composition may have a cross sectional area c1, each of the segmented portions of the second rubber composition may have a cross sectional area c2, where c1<c2.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a cross sectional view of a motorcycle tire.

FIG. 2 is a cross sectional view of a motorcycle tire having worn tire tread.

FIG. 3 is a front perspective view of a motorcycle tire.

FIG. 3A is an exploded view of FIG. 3.

FIG. 4 is a cross sectional view of the tread of the present invention.

FIG. 5 is a cross sectional view of a second embodiment of the present invention.

FIG. 6 is a cross sectional view of a third embodiment of the present invention.

FIG. 7 is a cross sectional view of another embodiment of the present invention.

### IV. DESCRIPTION OF THE INVENTION

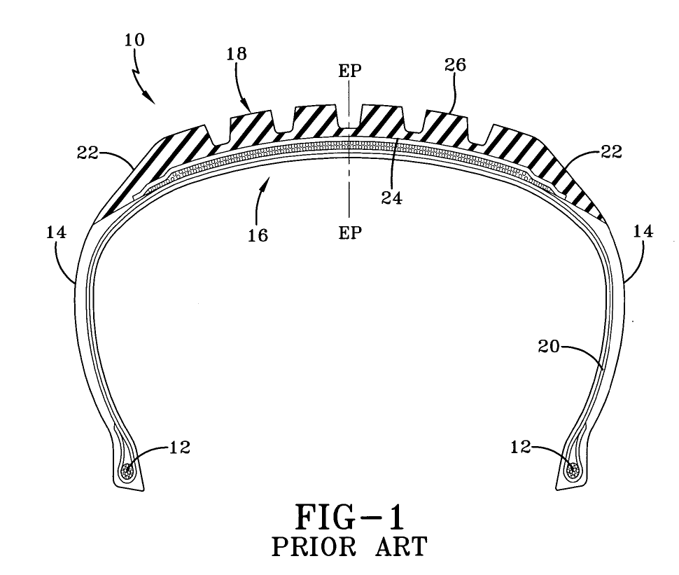

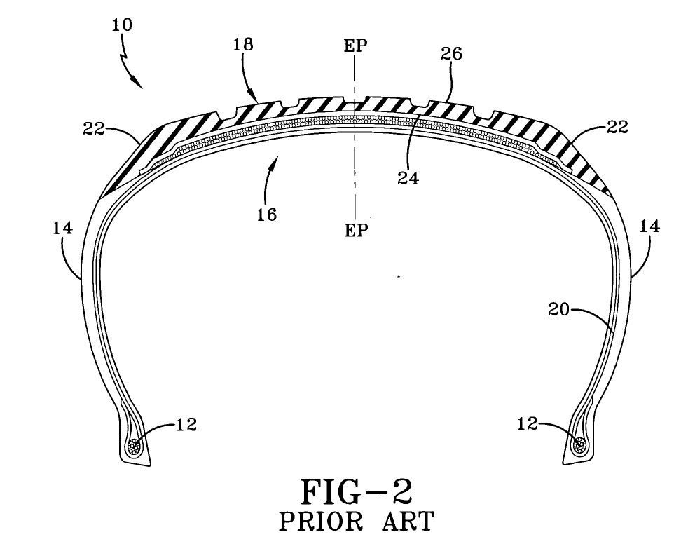

Referring now to the drawings wherein the showings are for purposes of illustrating a preferred embodiment of the invention only and not for purposes of limiting the same, FIGURES 1-7 show the present invention. With reference to FIG. 1, a motorcycle tire 10 well known in the art is shown. By way of example, the following description provides details of general tire components. There is shown a motorcycle tire 10, which is a toroidal-shaped composite structure which is provided with a pair of circular substantially inextensible beads 12 for mounting of the tire on a rim. The tire 10 has an equatorial plane EP, which is the plane perpendicular to the tire's axis of rotation and passing through the center of its tread 18. A pair of sidewalls 14 extends from the beads 12 respectively to a crown portion 16, which extends circumferentially about the tire 10. Tread 18 for engaging the ground is provided on the outer periphery of the crown portion 16. A carcass of two or more plies 20 of elastomer-impregnated fabric extends between the beads 12 to provide reinforcement in the sidewalls 14 and crown portion 16 of the tire. These plies 20 may be comprised of a plurality of generally parallel reinforcing cords (not shown) which extend at a cord angle not greater than about 75 degrees. The cords of one ply extending at the same angle but in an opposed direction to the cords of the other ply such that the cords of one ply cross the cords of the other ply in a manner commonly known to those of ordinary skill in the art to which this invention pertains. Cord angle means that angle at which cords of a ply or belt extend relative to and at the mid-circumferential plane of a tire. The tread 18 further comprises tread edges 22, which are the outermost points of a tire 10. The tread edges 22 touch the ground as the tire travels through its footprint while mounted on a vehicle under rated load and pressure. The carcass cords (not shown) may be made of any suitable material such as, by way of example only, nylon, rayon, polyester, fiberglass, aramid, or wire.

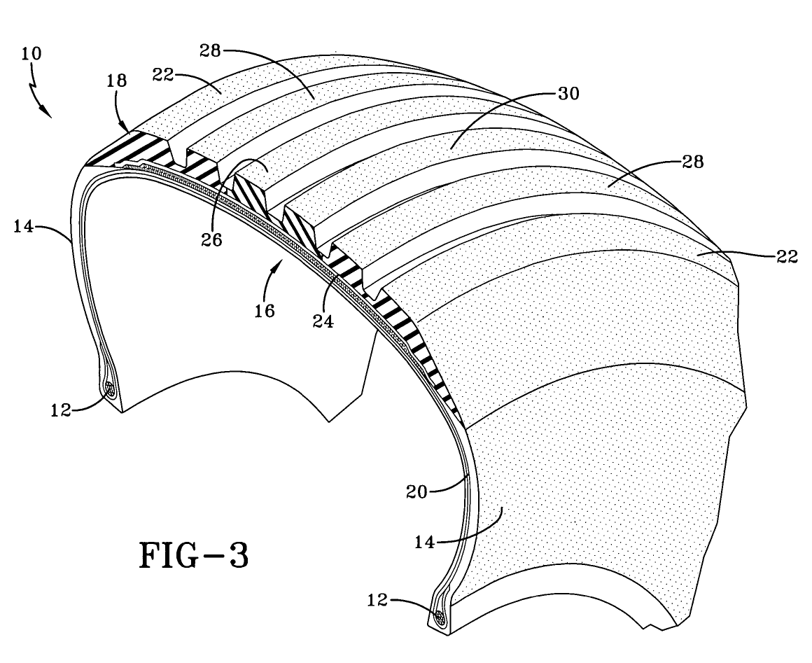

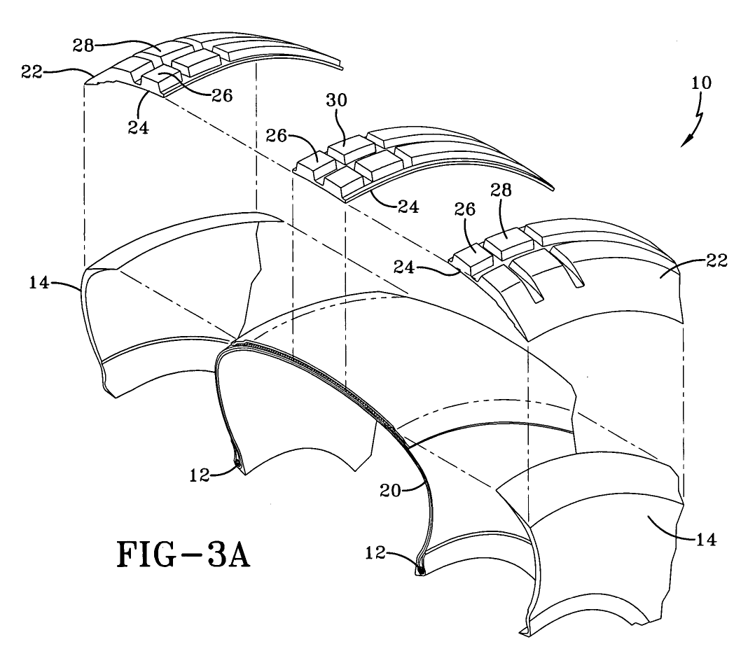

With reference now to FIGS. 3 and 3A, the tread 18 further includes a first rubber composition 28 having a working temperature and a second rubber composition 30 having a working temperature, wherein the first rubber composition 28 reaches its working temperature faster than said second rubber composition 30 reaches its working temperature. As shown in FIGS. 3 and 3A, the pair of sidewalls 14 may be comprised of the first rubber composition 28. Because of the different characteristics of the first and second rubber compositions 28, 30, the second rubber composition 30 provides better wear, while the first rubber composition 28 provides increased grip or traction on an underlying surface. The two compositions used together provide increased tire performance and simultaneously increases tire life since wear on the tread 18 will be more even.

With continuing reference to FIGS. 3 and 3A, the tread 18 comprises a tread base 24 and a tread cap 26. The first rubber composition 28 and the second rubber composition 30 extend from the tread base 24 to the tread cap 26.

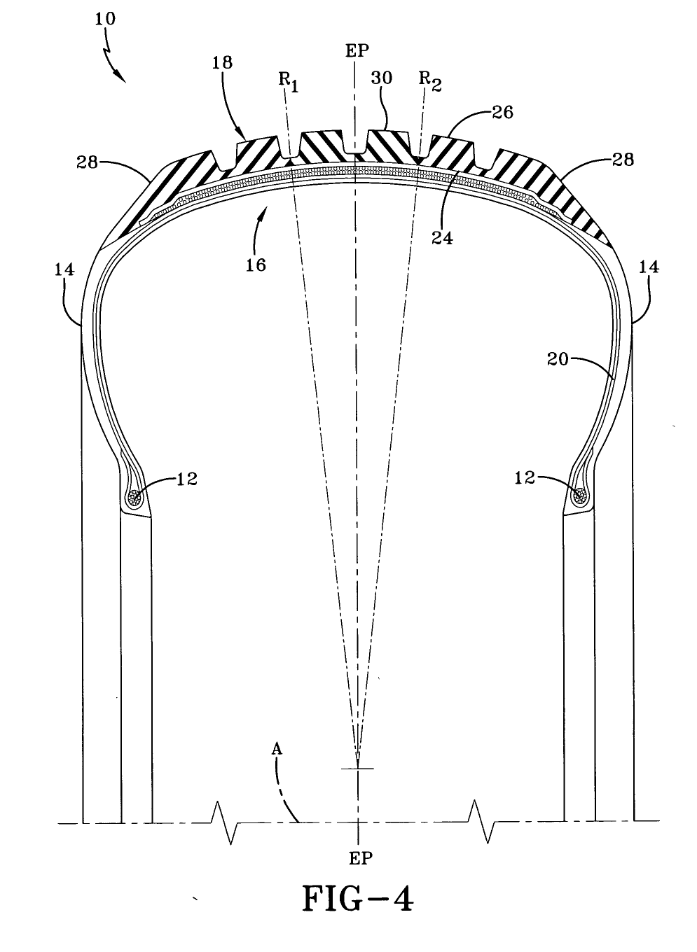

With reference now to FIG. 4, the tire 10 has a first radius r1 and a second radius r2 extending from an axis of rotation A of the tire 10. With respect to the radii discussed herein, any reference point chosen with sound engineering judgment may be used to define the radii. The first and second radii r1, r2 intersect the tread 18. As shown in FIG. 4, the second rubber composition 30 may be juxtaposed to the first rubber composition 28 and may be located between the first and second radii r1, r2.

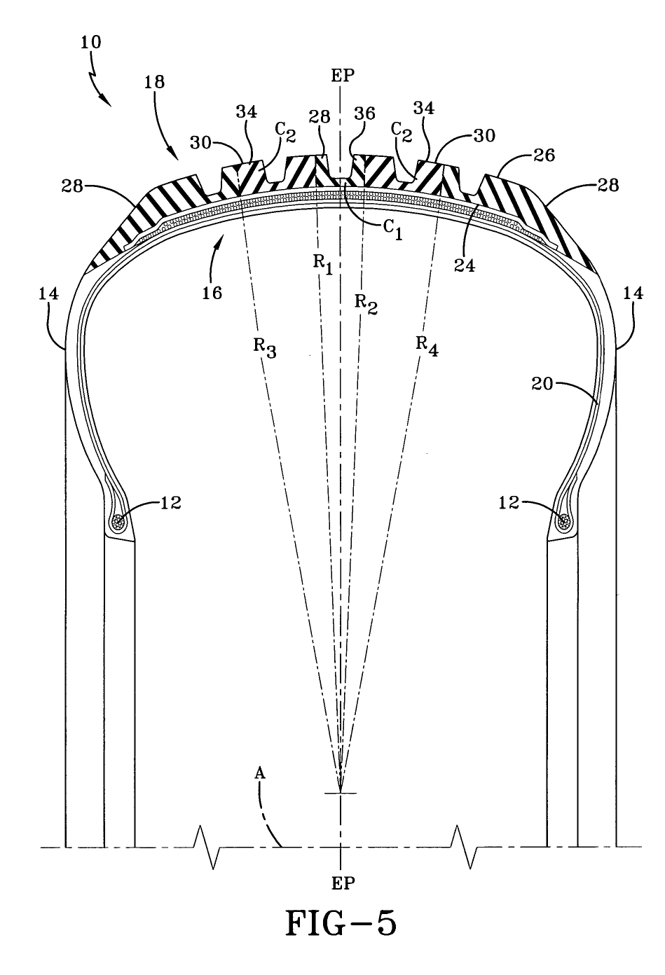

FIG. 5 shows another embodiment of the present invention. In FIG. 5, a portion 36 of the first rubber composition 28 may be juxtaposed between the second rubber composition 30 such that the second rubber composition 30 is segmented into two portions 34. As shown, the first rubber composition 28 has a cross sectional area c1. Each of the segmented portions 34 of the second rubber composition 30 has a cross sectional area c2, wherein c1<c2. It is also contemplated to be within the scope of the invention that c1>c2. Again, because of the positioning of the first and second rubber compositions 28, 30, the tire 10 provides increased performance and has more even wear due to the first rubber composition 28 and the second rubber composition 30 being in contact with the underlying surface.

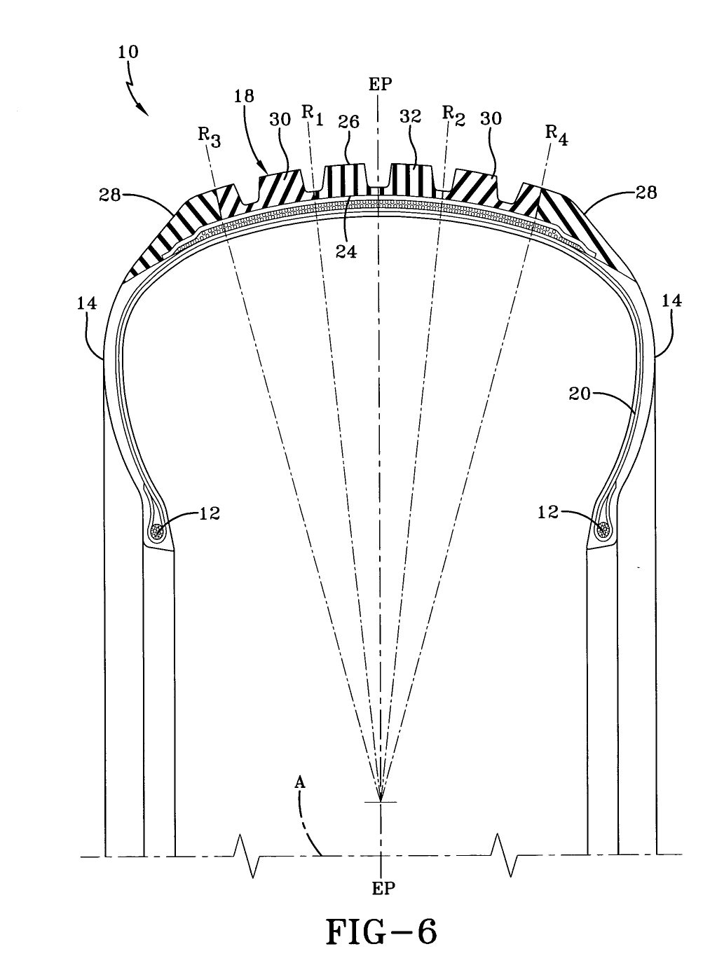

With reference to FIG. 6, yet another embodiment of the present invention is shown. In this embodiment, a third rubber composition 32 may be introduced to the tire tread 18. The third composition 32 also has a working temperature, and it reaches its working temperature slower than the second rubber composition 30 reaches its working temperature. As shown in FIG. 6, the tire 10 has a first radius r1, a second radius r2, a third radius r3, and a fourth radius r4. Each of the radii, r1, r2, r3, r4 may extend from the axis of rotation A and intersect the tread 18. The third rubber composition 32 may be juxtaposed to the second rubber composition 30 between the first radius r1 and the second radius r2. The second rubber composition 30 may be juxtaposed to the first rubber composition 28 and the third rubber composition 32 between the first and third radii. The third rubber composition 32 may also be juxtaposed to the first rubber composition 28 and the third rubber composition 32 between the second and fourth radii.

As can be seen from the FIGURES, any combination of the first, second, and third rubber compositions 28, 30, 32 may be utilized in the tread 18 that is chosen with sound engineering judgment. The positioning of the first, second, and third rubber compositions 28, 30, 32 may be symmetrical about the equatorial plane EP. The present invention enables the tire tread 18 to wear more evenly than tires known in the art and simultaneously does not compromise tire performance. With respect to the first, second, and third rubber compositions 28, 30, 32, the first rubber composition 28 may be a soft rubber. The second and third rubber compositions 30, 32 may generally be a medium and hard rubber, respectively. Further, the first rubber composition 28, the second rubber composition 30, and the third rubber composition 32 should be consistent or continuous, meaning that the rubber composition is basically the same rubber composition throughout the designated rubber components.

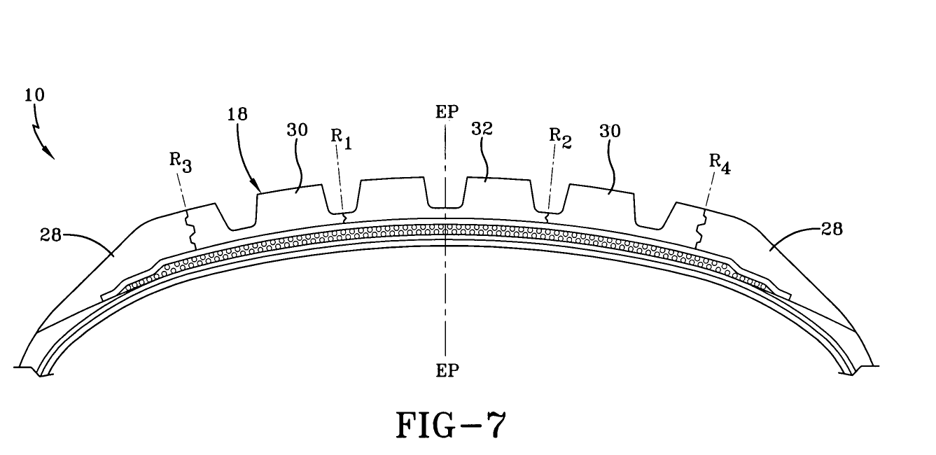

The tire 10 described herein is adapted to be used on motorcycles. Further, it can be manufactured with a multi-plex extruder, so that all of the tread components, namely the tread base 24 and tread cap 26, are in general practice extruded together in a multi-plex extruder to form a tread strip construction. Multi-plex extruders are known in the art and will not be further described herein. In an alternative embodiment, the different rubber compositions may interlock as shown in FIG. 7.

The inventive tire 10 may also be described as polyvalent, meaning it has more than one valence, which is the quality that determines the number of atoms or groups with which any single atom or group will unite chemically. The first rubber composition 28 may have a first valence, and the second rubber composition 30 may have a second valence. The third rubber composition 32 may have a third valence.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A tire, comprising:
a pair of beads;
a carcass extending between said beads;
a tread disposed outwardly of said carcass, said tread having tread edges; and
a pair of sidewalls extending from said tread edges to said respective beads, wherein said tread further includes:
a first rubber composition having a working temperature; and
a second rubber composition having a working temperature, wherein said first rubber composition reaches its working temperature faster than said second rubber composition reaches its working temperature.

2. The tire of claim 1, wherein said pair of sidewalls is comprised of said first rubber composition.

3. The tire of claim 1, wherein said tread further comprises a third rubber composition having a working temperature.

4. The tire of claim 3, wherein said third rubber composition reaches its working temperature slower than said second rubber composition reaches its working temperature.

5. The tire of claim 1, wherein said tire has a first radius and a second radius, said first and said second radii intersecting said tread, wherein said second rubber composition is juxtaposed to said first rubber composition and is between said first and said second radii.

6. The tire of claim 5, wherein a portion of said first rubber composition is juxtaposed between said second rubber composition such that said second rubber composition is segmented into two portions.

7. The tire of claim 6, wherein said first rubber composition has a cross sectional area c1, each of said segmented portions of said second rubber composition has a cross sectional area c2, where c1<c2.

8. The tire of claim 1, wherein a portion of said first rubber composition and a portion of said second rubber composition are adapted to contact an associated underlying surface, the combination of said first rubber composition and said second rubber composition adapted to provide even wear across said tread.

9. The tire of claim 1, wherein said tire is a motorcycle tire.

10. The tire of claim 1, wherein said first rubber composition is a soft rubber and said second rubber composition is a hard rubber.

11. The tire of claim 4, wherein said second rubber composition is a medium rubber.

12. A motorcycle tire, comprising:
a pair of beads;
a carcass extending between said beads;
a tread disposed outwardly of said carcass, said tread having tread edges; and
a pair of sidewalls extending from said tread edges to said respective beads, wherein said tread further includes:
a first rubber composition having a working temperature, said first rubber composition being a soft rubber; and
a second rubber composition having a working temperature, wherein said first rubber composition reaches its working temperature faster than said second rubber composition reaches its working temperature.

13. The motorcycle tire of claim 12, wherein said tread further comprises a tread base and a tread cap, said first rubber composition and said second rubber composition extending from said tread base to said tread cap.

14. The motorcycle tire of claim 12, wherein said second rubber composition is a medium rubber.

15. The motorcycle tire of claim 12, wherein said second rubber composition is a hard rubber.

16. The motorcycle tire of claim 13, wherein said tread further comprises a third rubber composition having a working temperature.

17. The motorcycle tire of claim 16, wherein said third rubber composition reaches its working temperature slower than said second rubber composition reaches its working temperature.

18. The motorcycle tire of claim 13, wherein said tire has a first radius and a second radius, said first and said second radii intersecting said tread, wherein said second rubber composition is juxtaposed to said first rubber composition and is between said first and said second radii.

19. The motorcycle tire of claim 13, wherein said tire has a first radius, a second radius, a third radius and a fourth radius, each of said radii intersecting said tread, said tread further comprising a third rubber composition, wherein said third rubber composition is juxtaposed to said second rubber composition between said first radii and said second radii, said second rubber composition is juxtaposed to said first rubber composition and said third rubber composition between said first and said third radii, said third rubber composition also juxtaposed to said first rubber composition and said third rubber composition between said second and said fourth radii.

20. A motorcycle tire, comprising:
a pair of beads;
a carcass extending between said beads;
a tread disposed outwardly of said carcass, said tread having tread edges said tread further comprising a tread base and a tread cap;
a first radius and a second radius intersecting said tread; and
a pair of sidewalls extending from said tread edges to said respective beads, wherein said tread further includes:
a first rubber composition having a working temperature, said first rubber composition being a soft rubber; and
a second rubber composition having a working temperature, said first rubber composition and said second rubber composition adapted to contact an associated underlying surface;
wherein said first rubber composition and said second rubber composition extend from said tread base to said tread cap, said first rubber composition reaches its working temperature faster than said second rubber composition reaches its working temperature, wherein said second rubber composition is juxtaposed to said first rubber composition and is between said first and said second radii.
